(19) United States
(12) Patent Application Publication
(10) Pub. No.: US 2016/0036092 A1
(43) Pub. Date: Feb. 4, 2016

(54) LITHIUM-ION BATTERY AND ELECTROLYTE THEREOF

(71) Applicants: Ningde Amperex Technology Limited, Ningde (CN); Dongguan Amperex Technology Limited, Dongguan (CN)

(72) Inventors: Shite YE, Dongguan (CN); Song LI, Dongguan (CN); Chenghua FU, Dongguan (CN); Chunbo CHU, Dongguan (CN)

(21) Appl. No.: 14/810,145

(22) Filed: Jul. 27, 2015

(30) Foreign Application Priority Data
Jul. 31, 2014 (CN) 201410374264.3

(51) Int. Cl. H01M 10/0567; H01M 4/133; H01M 4/525; H01M 10/0568; H01M 4/587; H01M 4/62; H01M 10/0525; H01M 10/0569; H01M 4/131; H01M 4/505

(52) U.S. Cl. CPC H01M 10/0567; H01M 4/131; H01M 4/133; H01M 4/525; H01M 4/505; H01M 4/587; H01M 4/623; H01M 4/622; H01M 4/625; H01M 10/0525; H01M 10/0569; H01M 10/0568; H01M 2004/028

(57) ABSTRACT

The present disclosure provides a lithium-ion battery and an electrolyte thereof. The electrolyte of the lithium-ion battery comprises: a non-aqueous organic solvent; a lithium salt discloved in the non-aqueous organic solvent; and an additive dissolved in the non-aqueous organic solvent. The additive comprises 1,3-dioxo-heterocyclic compound with a structural formula I and fluoroethylene carbonate; in the structural formula I, R₁ and R₂ each independently are H, methyl or ethyl; n is an integer selected from 1˜3; a weight percentage of 1,3-dioxo-heterocyclic compound with the structural formula I in the electrolyte of the lithium-ion battery is 0.05%˜5%; a weight percentage of fluoroethylene carbonate in the electrolyte of the lithium-ion battery is 1%˜8%. The lithium-ion battery comprises the aforementioned electrolyte of the lithium-ion battery. The lithium-ion battery of the present disclosure has an excellent high temperature storage performance and an excellent low temperature discharge rate performance.

### CROSS-REFERENCE TO RELATED APPLICATIONS

The present application claims priority to Chinese patent application No. CN201410374264.3, filed on Jul. 31, 2014, which is incorporated herein by reference in its entirety.

### FIELD OF THE PRESENT DISCLOSURE

The present disclosure relates to a field of a battery technology, and more specifically to a lithium-ion battery and an electrolyte thereof.

### BACKGROUND OF THE PRESENT DISCLOSURE

With popularization and application of portable electronic devices, higher requirements on application environment of a lithium-ion battery is required. In order to meet the application requirement of an electrolyte under a wider temperature range, the conventional non-aqueous organic solvent of the electrolyte is mainly comprised of chain ester and cyclic ester.

U.S. Pat. No. 6,506,524B1 issued on Jan. 14, 2003 discloses an alkali metal-ion battery, in which, fluoroethylene carbonate (FEC) and propylene carbonate are added into an electrolyte in order to prevent short circuit caused by growth of bark-like crystal (or dendritic crystal) in charging process of the alkali metal-ion battery. However, because fluoroethylene carbonate (FEC) is easily reduced, especially under high temperature, fluoroethylene carbonate (FEC) is easily decomposed on a negative electrode plate and in turn decomposed to produce hydrogen fluoride (HF) gas or organic gas.

In order to inhibit gas production from fluoroethylene carbonate (FEC), Chinese patent application published as CN101252205A on Aug. 27, 2008 discloses a technical scheme that an inorganic insulating material particle layer is formed on a surface of a positive electrode plate, a negative electrode plate or a separator of a non-aqueous electrolyte secondary battery using fluoroethylene carbonate as an additive, so as to reduce the gas production due to decomposition of fluoroethylene carbonate (FEC).

However, the implementation of the above technical scheme will significantly increase the difficulty in transmission of the lithium ions between the electrode plate and the separator within the battery, and reduce the transmission rate of the lithium ions within the battery. Furthermore, it is possible to increase the difficulty in the manufacturing process of the electrode plate, and make negative effects on flexibility and processability of the electrode plate. Inventors of the present disclosure have also found that, with the above technical scheme that the inorganic insulating material particle layer is formed on the surface of the positive electrode plate, the negative electrode plate or the separator, it is difficult to completely inhibit decomposition of fluoroethylene carbonate, the HF gas due to decomposition of fluoroethylene carbonate can pass through pores of the separator into the surface of the positive electrode plate, and in turn corrode the positive active material. The corrosion is more serious especially under high temperature for a long period, and will seriously affect the high temperature storage performance and the long service life of the lithium-ion battery.

Moreover, fluoroethylene carbonate, as a conventional additive for solid electrolyte interface (SEI) film, will form a SEI film on the surface of the negative active material, and also increase the impedance of the negative active material, and affect the transmission performance of the lithium ions, and further affect the low temperature discharge rate performance of the lithium-ion battery. Therefore it is necessary to seek a more reliable and effective method to improve the performances of the lithium-ion battery.

### SUMMARY OF THE PRESENT DISCLOSURE

In view of the problems existing in the background of the present disclosure, an object of the present disclosure is to provide a lithium-ion battery and an electrolyte thereof, the lithium-ion battery has an excellent high temperature storage performance and an excellent low temperature discharge rate performance.

In order to achieve the above object, in a first aspect of the present disclosure, the present disclosure provides an electrolyte of a lithium-ion battery which comprises: a non-aqueous organic solvent; a lithium salt dissolved in the non-aqueous organic solvent; and an additive dissolved in the non-aqueous organic solvent. The additive comprises 1,3-dioxo-heterocyclic compound with a structural formula I and fluoroethylene carbonate (FEC). In the structural formula I, R₁ and R₂ each independently are H, methyl or ethyl; n is an integer selected from 1˜3; a weight percentage of 1,3-dioxo-heterocyclic compound with the structural formula I in the electrolyte of the lithium-ion battery is 0.05%˜5%; a weight percentage of fluoroethylene carbonate (FEC) in the electrolyte of the lithium-ion battery is 1%˜8%.

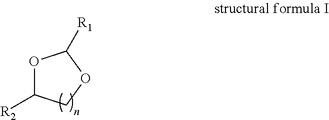

In a second aspect of the present disclosure, the present disclosure provides a lithium-ion battery which comprises: a positive electrode plate comprising a positive current collector and a positive film containing a positive active material and provided on the positive current collector; a negative electrode plate comprising a negative current collector and a negative film containing a negative active material and provided on the negative current collector; a separator positioned between the positive electrode plate and the negative electrode plate; an electrolyte; and an outer package. The electrolyte is the electrolyte of the lithium-ion battery according to the first aspect of the present disclosure.

The present disclosure has following beneficial effects:

(1) 1,3-dioxo-heterocyclic compound with the structural formula I of the present disclosure is an electrolyte additive which can form a stable positive SEI protective film on the surface of the positive electrode plate, especially because 1,3-dioxo-heterocyclic compound with the structural formula I can form the stable positive SEI protective film on the surface of the positive electrode plate before fluoroethylene carbonate (FEC) is decomposed into HF gas on the surface of the negative electrode plate, thereby avoiding the corrosion of the positive active material by HF gas, and further improving the high temperature storage performance of the lithium-ion battery.

(2) 1,3-dioxo-heterocyclic compound with the structural formula I of the present disclosure can also form a stable negative SEI protective film on the surface of the negative electrode plate together with fluoroethylene carbonate (FEC), and because 1,3-dioxo-heterocyclic compound with the structural formula I in the negative SEI protective film has a higher concentration of oxygen element, the transmission capability of the lithium ions on the negative SEI protective film on the surface of the negative active material is also improved, therefore the impedance of the lithium-ion battery is obviously decreased, and the low temperature discharge rate performance of the lithium-ion battery is improved.

### DETAILED DESCRIPTION

Hereinafter a lithium-ion battery and an electrolyte thereof and examples, comparative examples and test results according to the present disclosure will be described in detail.

Firstly, an electrolyte of a lithium-ion battery according to a first aspect of the present disclosure will be described.

An electrolyte of the lithium-ion battery according to a first aspect of the present disclosure comprises: a non-aqueous organic solvent; a lithium salt dissolved in the non-aqueous organic solvent; and an additive dissolved in the non-aqueous organic solvent. The additive comprises 1,3-dioxo-heterocyclic compound with a structural formula I and fluoroethylene carbonate (FEC). In the structural formula I, R₁ and R₂ each independently are H, methyl or ethyl; n is an integer selected from 1˜3; a weight percentage of 1,3-dioxo-heterocyclic compound with the structural formula I in the electrolyte of the lithium-ion battery is 0.05%˜5%; a weight percentage of fluoroethylene carbonate (FEC) in the electrolyte of the lithium-ion battery is 1%˜8%

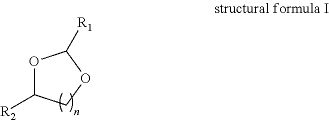

In the electrolyte of the lithium-ion battery according to the first aspect of the present disclosure, fluoroethylene carbonate (FEC) has a better performance on the formation of SEI protective film, and is beneficial for the capacity retention rate after cycling of the lithium-ion battery. However, when the lithium-ion battery is storaged under high temperature, fluoroethylene carbonate (FEC) will be decomposed into HF gas, which is the main reason resulting in the performance degradation and even the gas production in the lithium-ion battery. And 1,3-dioxo-heterocyclic compound with the structural formula I of the present disclosure is an electrolyte additive which can form a stable positive SEI protective film on the surface of the positive electrode plate, especially because 1,3-dioxo-heterocyclic compound with the structural formula I can form a stable positive SEI protective film on the surface of the positive electrode plate before fluoroethylene carbonate (FEC) is decomposed into HF gas on the surface of the negative electrode plate, thereby avoiding the corrosion of the positive active material by HF gas, and further improving the high temperature storage performance of the lithium-ion battery. Furthermore, 1,3-dioxo-heterocyclic compound with the structural formula I of the present disclosure can also form a negative SEI protective film on the surface of the negative electrode plate together with fluoroethylene carbonate (FEC), and because 1,3-dioxo-heterocyclic compound with the structural formula I in the negative SEI protective film has a higher concentration of oxygen element, the transmission capability of the lithium ions on the negative SEI protective film on the surface of the negative active material is also improved, therefore the impedance of the lithium-ion battery is obviously decreased, and the low temperature discharge rate performance of the lithium-ion battery is improved.

If the weight percentage of 1,3-dioxo-heterocyclic compound with the structural formula I in the electrolyte of the lithium-ion battery is less than 0.05%, 1,3-dioxo-heterocyclic compound with the structural formula I cannot fully function; if the weight percentage of 1,3-dioxo-heterocyclic compound with the structural formula I in the electrolyte of the lithium-ion battery is more than 5%, although 1,3-dioxo-heterocyclic compound with the structural formula I may significantly inhibit the corrosion on the positive active material by HF gas, however, the positive SEI protective film is relatively thick and dense, thereby hindering the normal deintercalation-intercalation process of the lithium ions, thereby resulting in a negative effect on the capacity of the lithium-ion battery, and also seriously affecting the low temperature discharge rate performance of the lithium-ion battery. If the weight percentage of fluoroethylene carbonate (FEC) in the electrolyte of the lithium-ion battery is less than 1%, fluoroethylene carbonate (FEC) cannot form a stable negative SEI protective film; if the weight percentage of fluoroethylene carbonate (FEC) in the electrolyte of the lithium-ion battery is more than 8%, it will aggravate the gas production of the lithium-ion battery.

In the electrolyte of the lithium-ion battery according to the first aspect of the present disclosure, the lithium salt may be one or more selected from a group consisting of LiN(CₐF₂ₐ₊₁SO₂)(C_{b}F_{2b+1}SO₂), LiPF₆, LiBF₄, LiBOB, LiAsF₆, LiCF₃SO₃ and LiClO₄, a and b each are natural number.

In the electrolyte of the lithium-ion battery according to the first aspect of the present disclosure, a concentration of the lithium salt may be 0.5M˜2.0M.

In the electrolyte of the lithium-ion battery according to the first aspect of the present disclosure, the non-aqueous organic solvent may comprise one or more selected from a group consisting of carbonate and carboxylate, the carbonate may comprise cyclic carbonate and chain carbonate.

In the electrolyte of the lithium-ion battery according to the first aspect of the present disclosure, the cyclic carbonate may comprise one or more selected from a group consisting of propylene carbonate (PC) and ethylene carbonate (EC); the chain carbonate may comprise one or more selected from a group consisting of dimethyl carbonate (DMC), ethyl methyl carbonate (EMC), and methyl propyl carbonate (MPC); the carboxylate may comprise one or more selected from a group consisting of γ-butyrolactone (GBL), methyl formate (MF), ethyl acetate (EA), and methyl butyrate (MB).

In the electrolyte of the lithium-ion battery according to the first aspect of the present disclosure, a volume of the chain carbonate may be 40%˜70% of a total volume of the non-aqueous organic solvent; a volume of the carboxylate may be 40%˜70% of the total volume of the non-aqueous organic solvent; a volume of the cyclic carbonate may be the residual percentage of the total volume of the non-aqueous organic solvent. If the volume of the chain carbonate is more than 70% of the total volume of the non-aqueous organic solvent, although it is beneficial for the electronic conductivity of the electrolyte, however, it will increase the risk of gas production under high temperature; if the volume of the chain carbonate is less than 40% of the total volume of the non-aqueous organic solvent, it has a negative effect on the electronic conductivity of the electrolyte under low temperature, and further affects the low temperature discharge rate performance of the lithium-ion battery.

In the electrolyte of the lithium-ion battery according to the first aspect of the present disclosure, 1,3-dioxo-heterocyclic compound with the structural formula I may comprise one or more selected from a group consisting of 1,3-dioxane (compound 1), 1,3-dioxolan (compound 2), 2-methyl-1,3-dioxane (compound 3), 2-methyl-1,3-dioxolan (compound 4), 2,6-dimethyl-1,3-dioxane (compound 5), and 2,5-dimethyl-1,3-dioxolan (compound 6),

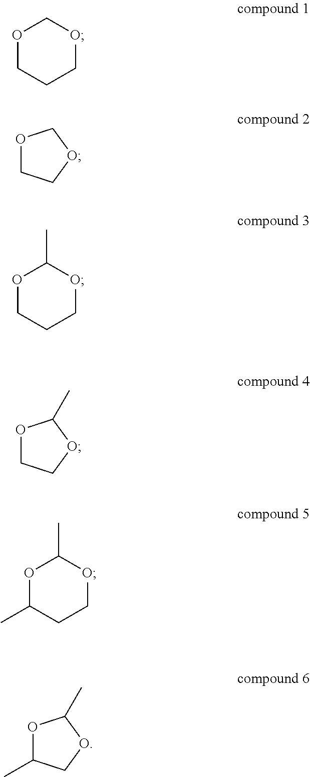

In the electrolyte of the lithium-ion battery according to the first aspect of the present disclosure, the weight percentage of 1,3-dioxo-heterocyclic compound with the structural formula I in the electrolyte of the lithium-ion battery may be 0.5%˜2%.

In the electrolyte of the lithium-ion battery according to the first aspect of the present disclosure, the weight percentage of fluoroethylene carbonate (FEC) in the electrolyte of the lithium-ion battery may be 2%˜4%.

Secondly, a lithium-ion battery according to a second aspect of the present disclosure will be described.

A lithium-ion battery according to a second aspect of the present disclosure comprises: a positive electrode plate comprising a positive current collector and a positive film containing a positive active material and provided on the positive current collector; a negative electrode plate comprising a negative current collector and a negative film containing a negative active material and provided on the negative current collector; a separator positioned between the positive electrode plate and the negative electrode plate; an electrolyte; and an outer package. The electrolyte is the electrolyte of the lithium-ion battery according to the first aspect of the present disclosure.

In the lithium-ion battery according to the second aspect of the present disclosure, the positive active material may comprise a lithium deintercalateion-intercalation material.

In the lithium-ion battery according to the second aspect of the present disclosure, the lithium deintercalateion-intercalation material in the positive active material may be lithium transition metal complex oxide. The lithium transition metal complex oxide may comprise one or more selected from a group consisting of lithium transition metal oxide, a compound containg lithium transition metal oxide and other transition metal or nontransition metal. The lithium transition metal complex oxide may comprise one or more selected from a group consisting of lithium cobalt oxide, lithium nickel oxide, lithium manganese oxide, lithium nickel manganese oxide, lithium nickel cobalt manganese oxide and lithium nickel cobalt aluminum oxide.

In the lithium-ion battery according to the second aspect of the present disclosure, the lithium transition metal complex oxide may comprise one or more selected from a group consisting of LiCoO₂ (LCO), LiNi_{1/3}Mn_{1/3}CO_{1/3}O₂ (NCM333), LiNi_{0.5}Mn_{0.3}CO_{0.2}O₂(NCM523), a compound containing LiCoO₂ (LCO) and other transition metal, a compound containing LiNi_{1.3}Mn_{1/3}CO_{1/3}O₂(NCM333) and other transition metal and a compound containing LiNi_{0.5}Mn_{0.3}Co_{0.2}O₂(NCM523) and other transition metal.

In the lithium-ion battery according to the second aspect of the present disclosure, the negative active material may comprise a lithium deintercalateion-intercalation material.

In the lithium-ion battery according to the second aspect of the present disclosure, the lithium deintercalateion-intercalation material in the negative active material may comprise one or more selected from a group consisting of soft carbon, hard carbon, artificial graphite, natural graphite, silicon, silicon oxide, silicon-carbon complex, lithium titanate and a metal which can form alloy with lithium.

### Example 1

### 1. Preparation of a Positive Electrode Plate of a Lithium-Ion Battery

Positive active material (LiNi_{1/3}Mn_{1/3}Co_{1/3}O₂ (NCM333)), conductive agent (acetylene black) and adhesive (polyvinylidene fluoride (PVDF)) according to a mass ratio of 96:2:2 were uniformly mixed with solvent (N-methyl-2-pyrrolidone (NMP)) to form a positive slurry, then the positive slurry was coated on current collector (Al foil), which was followed by drying, cold pressing, welding a tab, and the positive slurry became a positive film after dried, and finally a positive electrode plate of the lithium-ion battery was obtained.

### 2. Preparation of a Negative Electrode Plate of a Lithium-Ion Battery

Negative active material (artificial graphite), conductive agent (acetylene black), adhesive (styrene-butadiene rubber (SBR)) and thickening agent (sodium carboxymethyl cellulose (CMC)) according to a mass ratio of 95:2:2:1 were uniformly mixed with solvent (deionized water) to form a negative slurry, then the negative slurry was coated on current collector (Cu foil), which was followed by drying, cold pressing, welding a tab, and the negative slurry became a negative film after dried, and finally a negative electrode plate of the lithium-ion battery was obtained.

### 3. Preparation of a Separator of a Lithium-Ion Battery

The separator of the lithium-ion battery was PE porous polymeric membrane.

### 4. Preparation of an Electrolyte of a Lithium-Ion Battery

The electrolyte of the lithium-ion battery used a concentration of 1 mol/L of LiPF₆ as lithium salt, and used a mixture of ethylene carbonate (EC), propylene carbonate (PC) and methyl ethyl carbonate (EMC) (the volume ratio was 30:5:65) as non-aqueous organic solvent, and used a mixture of fluoroethylene carbonate (FEC) with a weight percentage of 1% in the electrolyte of the lithium-ion battery and 1,3-dioxane (compound 1) with a weight percentage of 1% in the electrolyte of the lithium-ion battery as additive.

### 5. Preparation of a Lithium-Ion Battery

The positive electrode plate, the separator and the negative electrode plate were sequentially placed and wound together to form a cell, and the separator was positioned between the positive electrode plate and the negative electrode plate to separate the positive electrode plate and the negative electrode plate, then the cell was positioned in an outer package, which was followed by injecting the electrolyte, packaging and formation, finally a lithium-ion battery was obtained.

### Example 2

The lithium-ion battery was prepared the same as that in example 1 except the following difference:

### 4. Preparation of an Electrolyte of a Lithium-Ion Battery

The weight percentage of fluoroethylene carbonate (FEC) in the electrolyte of the lithium-ion battery was 2%.

### Example 3

The lithium-ion battery was prepared the same as that in example 1 except the following difference:

### 4. Preparation of an Electrolyte of a Lithium-Ion Battery

The weight percentage of fluoroethylene carbonate (FEC) in the electrolyte of the lithium-ion battery was 3%.

### Example 4

The lithium-ion battery was prepared the same as that in example 1 except the following difference:

### 4. Preparation of an Electrolyte of a Lithium-Ion Battery

The weight percentage of fluoroethylene carbonate (FEC) in the electrolyte of the lithium-ion battery was 4%.

### Example 5

The lithium-ion battery was prepared the same as that in example 1 except the following difference:

### 4. Preparation of an Electrolyte of a Lithium-Ion Battery

The weight percentage of fluoroethylene carbonate (FEC) in the electrolyte of the lithium-ion battery was 8%.

### Example 6

The lithium-ion battery was prepared the same as that in example 3 except the following difference:

### 4. Preparation of an Electrolyte of a Lithium-Ion Battery

The weight percentage of 1,3-dioxane (compound 1) in the electrolyte of the lithium-ion battery was 0.05%.

### Example 7

The lithium-ion battery was prepared the same as that in example 3 except the following difference:

### 4. Preparation of an Electrolyte of a Lithium-Ion Battery

The weight percentage of 1,3-dioxane (compound 1) in the electrolyte of the lithium-ion battery was 0.5%.

### Example 8

The lithium-ion battery was prepared the same as that in example 3 except the following difference:

### 4. Preparation of an Electrolyte of a Lithium-Ion Battery

The weight percentage of 1,3-dioxane (compound 1) in the electrolyte of the lithium-ion battery was 2%.

### Example 9

The lithium-ion battery was prepared the same as that in example 3 except the following difference:

### 4. Preparation of an Electrolyte of a Lithium-Ion Battery

The weight percentage of 1,3-dioxane (compound 1) in the electrolyte of the lithium-ion battery was 5%.

### Example 10

The lithium-ion battery was prepared the same as that in example 1 except the following difference:

### 4. Preparation of an Electrolyte of a Lithium-Ion Battery

The additive was a mixture of fluoroethylene carbonate (FEC) with a weight percentage of 3% in the electrolyte of the lithium-ion battery and 1,3-dioxolan (compound 2) with a weight percentage of 1% in the electrolyte of the lithium-ion battery.

### Example 11

The lithium-ion battery was prepared the same as that in example 1 except the following difference:

### 4. Preparation of an Electrolyte of a Lithium-Ion Battery

The additive was a mixture of fluoroethylene carbonate (FEC) with a weight percentage of 3% in the electrolyte of the lithium-ion battery and 2-methyl-1,3-dioxane (compound 3) with a weight percentage of 1% in the electrolyte of the lithium-ion battery.

### Example 12

The lithium-ion battery was prepared the same as that in example 1 except the following difference:

### 4. Preparation of an Electrolyte of a Lithium-Ion Battery

The additive was a mixture of fluoroethylene carbonate (FEC) with a weight percentage of 3% in the electrolyte of the lithium-ion battery and 2-methyl-1,3-dioxolan (compound 4) with a weight percentage of 1% in the electrolyte of the lithium-ion battery.

### Example 13

The lithium-ion battery was prepared the same as that in example 1 except the following difference:

### 4. Preparation of an Electrolyte of a Lithium-Ion Battery

The additive was a mixture of fluoroethylene carbonate (FEC) with a weight percentage of 3% in the electrolyte of the lithium-ion battery and 2,6-dimethyl-1,3-dioxane (compound 5) with a weight percentage of 1% in the electrolyte of the lithium-ion battery.

### Example 14

The lithium-ion battery was prepared the same as that in example 1 except the following difference:

### 4. Preparation of an Electrolyte of a Lithium-Ion Battery

The additive was a mixture of fluoroethylene carbonate (FEC) with a weight percentage of 3% in the electrolyte of the lithium-ion battery and 2,5-dimethyl-1,3-dioxolan (compound 6) with a weight percentage of 1% in the electrolyte of the lithium-ion battery.

### Example 15

The lithium-ion battery was prepared the same as that in example 3 except the following difference:

### 1. Preparation of a Positive Electrode Plate of a Lithium-Ion Battery

The positive active material was LiNi_{0.5}Mn_{0.3}Co_{0.2}O₂ (NCM523).

### Example 16

The lithium-ion battery was prepared the same as that in example 3 except the following difference:

### 1. Preparation of a Positive Electrode Plate of a Lithium-Ion Battery

The positive active material was LiCoO₂ (LCO).

### Comparative Example 1

The lithium-ion battery was prepared the same as that in example 1 except the following difference:

### 4. Preparation of an Electrolyte of a Lithium-Ion Battery

There was no additive in the electrolyte of the lithium-ion battery.

### Comparative Example 2

The lithium-ion battery was prepared the same as that in example 1 except the following difference:

### 4. Preparation of an Electrolyte of a Lithium-Ion Battery

The additive was fluoroethylene carbonate (FEC) with a weight percentage of 5% in the electrolyte of the lithium-ion battery.

### Comparative Example 3

The lithium-ion battery was prepared the same as that in example 1 except the following difference:

### 4. Preparation of an Electrolyte of a Lithium-Ion battery

The additive was 1,3-dioxane (compound 1) with a weight percentage of 3% in the electrolyte of the lithium-ion battery.

### Comparative Example 4

The lithium-ion battery was prepared the same as that in example 15 except the following difference:

### 4. Preparation of an Electrolyte of a Lithium-Ion battery

There was no additive in the electrolyte of the lithium-ion battery.

### Comparative Example 5

The lithium-ion battery was prepared the same as that in example 3 except the following difference:

### 4. Preparation of an Electrolyte of a Lithium-Ion battery

The weight percentage of 1,3-dioxane (compound 1) in the electrolyte of the lithium-ion battery was 6%.

### Comparative Example 6

The lithium-ion battery was prepared the same as that in example 1 except the following difference:

### 4. Preparation of an Electrolyte of a Lithium-Ion Battery

The weight percentage of fluoroethylene carbonate (FEC) in the electrolyte of the lithium-ion battery was 10%.

Finally tests and test results of examples 1-16 and comparative examples 1-6 of the lithium-ion battery and the electrolyte thereof were presented.

(1) Testing of the High Temperature Storage Performance of the Lithium-Ion Battery

At 25° C., five lithium-ion batteries of each of examples and comparative examples was charged to a voltage more than 4.35V at a constant current of 0.5 C, and then charged to a current less than 0.05 C at a constant voltage of 4.35V to make the lithium-ion battery full charged, a thickness of the full charged lithium-ion battery before storage was measured and recorded as D₀, then the full charged lithium-ion battery was placed in an oven at 60° C. and taken out after 21 days, a thickness of the lithium-ion battery after storage was immediately measured and recorded as D₁.

The high temperature thickness expansion rate s of the lithium-ion battery (%)=(D₁−D₀)/D₀×100%.

An average value of the high temperature thickness expansion rates of the five lithium-ion batteries was taken as the high temperature thickness expansion rate of this lithium-ion battery.

(2) Testing of the Low Temperature Discharge Rate Performance of the Lithium-Ion Battery

At 25° C., five lithium-ion batteries of each of examples and comparative examples was charged to a voltage more than 4.35V at a constant current of 0.5 C, and then charged to a current less than 0.05 C at a constant voltage of 4.35V, then respectively placed under 25° C. and −10° C. for 60 mins, then discharged to a voltage of 3.0V at a constant current of 0.2 C. The discharge capacity of the lithium-ion battery under different temperatures D(25° C.) and D(−10° C.) were recorded.

The low temperature discharge rate of the lithium-ion battery (%)=D(−10° C.)/D(25° C.)×100%.

An average value of the low temperature discharge rates of the five lithium-ion batteries was taken as the low temperature discharge rate of this lithium-ion battery.

Table 1 illustrated related parameters and test results of examples 1-16 and comparative examples 1-6.

TABLE 1
Related parameters and test results of examples 1-16 and comparative examples 1-6

| | | | | | | high temperature | low |
|---|---|---|---|---|---|---|---|
| | positive | non-aqueous organic | | 1,3-dioxo-heterocyclic | | thickness | temperature |
| | active | solvent | FEC | compound | | expansion rate | discharge |
| | material | lithium salt | content | content | name | ε | rate |
| example 1 | NCM333 | EC:PC:EMC = 30:5:65 | 1% | 1% | compound 1 | 50% | 87% |
| | | 1M LiPF₆ | | | | | |
| example 2 | NCM333 | EC:PC:EMC = 30:5:65 | 2% | 1% | compound 1 | 35% | 89% |
| | | 1M LiPF₆ | | | | | |
| example 3 | NCM333 | EC:PC:EMC = 30:5:65 | 3% | 1% | compound 1 | 12% | 94% |
| | | 1M LiPF₆ | | | | | |
| example 4 | NCM333 | EC:PC:EMC = 30:5:65 | 4% | 1% | compound 1 | 20% | 90% |
| | | 1M LiPF₆ | | | | | |
| example 5 | NCM333 | EC:PC:EMC = 30:5:65 | 8% | 1% | compound 1 | 55% | 85% |
| | | 1M LiPF₆ | | | | | |
| example 6 | NCM333 | EC:PC:EMC = 30:5:65 | 3% | 0.05% | compound 1 | 52% | 87% |
| | | 1M LiPF₆ | | | | | |
| example 7 | NCM333 | EC:PC:EMC = 30:5:65 | 3% | 0.5% | compound 1 | 39% | 88% |
| | | 1M LiPF₆ | | | | | |
| example 8 | NCM333 | EC:PC:EMC = 30:5:65 | 3% | 2% | compound 1 | 16% | 93% |
| | | 1M LiPF₆ | | | | | |
| example 9 | NCM333 | EC:PC:EMC = 30:5:65 | 3% | 5% | compound 1 | 42% | 88% |
| | | 1M LiPF₆ | | | | | |
| example 10 | NCM333 | EC:PC:EMC = 30:5:65 | 3% | 1% | compound 2 | 14% | 95% |
| | | 1M LiPF₆ | | | | | |
| example 11 | NCM333 | EC:PC:EMC = 30:5:65 | 3% | 1% | compound 3 | 16% | 92% |
| | | 1M LiPF₆ | | | | | |
| example 12 | NCM333 | EC:PC:EMC = 30:5:65 | 3% | 1% | compound 4 | 19% | 90% |
| | | 1M LiPF₆ | | | | | |
| example 13 | NCM333 | EC:PC:EMC = 30:5:65 | 3% | 1% | compound 5 | 20% | 89% |
| | | 1M LiPF₆ | | | | | |
| example 14 | NCM333 | EC:PC:EMC = 30:5:65 | 3% | 1% | compound 6 | 22% | 88% |
| | | 1M LiPF₆ | | | | | |
| example 15 | NCM523 | EC:PC:EMC = 30:5:65 | 3% | 1% | compound 1 | 18% | 92% |
| | | 1M LiPF₆ | | | | | |
| example 16 | LCO | EC:PC:EMC = 30:5:65 | 3% | 1% | compound 1 | 47% | 85% |
| | | 1M LiPF₆ | | | | | |
| comparative | NCM333 | EC:PC:EMC = 30:5:65 | / | / | / | 56% | 83% |
| example 1 | | 1M LiPF₆ | | | | | |
| comparative | NCM333 | EC:PC:EMC = 30:5:65 | 5% | / | / | 55% | 66% |
| example 2 | | 1M LiPF₆ | | | | | |
| comparative | NCM333 | EC:PC:EMC = 30:5:65 | / | 3% | compound 1 | 69% | 83% |
| example 3 | | 1M LiPF₆ | | | | | |
| comparative | NCM523 | EC:PC:EMC = 30:5:65 | / | / | / | 59% | 84% |
| example 4 | | 1M LiPF₆ | | | | | |
| comparative | NCM333 | EC:PC:EMC = 30:5:65 | 3% | 6% | compound 1 | 55% | 76% |
| example 5 | | 1M LiPF₆ | | | | | |
| comparative | NCM333 | EC:PC:EMC = 30:5:65 | 10% | 1% | compound 1 | 65% | 82% |
| example 6 | | 1M LiPF₆ | | | | | |

Next, analyses of the test results of the lithium-ion batteries were presented.

As could be seen from the comparison between examples 1-14 and comparative examples 1˜3, the lithium-ion battery of the present disclosure comprising 1,3-dioxo-heterocyclic compound with the structural formula I and fluoroethylene carbonate (FEC) had a lower high temperature thickness expansion rate and a higher low temperature discharge rate compared with the lithium-ion battery comprising no additive (comparative example 1) and the lithium-ion battery comprising only fluoroethylene carbonate (FEC) (comparative example 2) and the lithium-ion battery comprising only 1,3-dioxo-heterocyclic compound with the structural formula I (comparative example 3). This was because both the single 1,3-dioxo-heterocyclic compound with the structural formula I and the single fluoroethylene carbonate (FEC) would deteriorate the high temperature storage performance and the low temperature discharge rate performance of the lithium-ion battery. However, when fluoroethylene carbonate (FEC) and 1,3-dioxo-heterocyclic compound with the structural formula I were used together, 1,3-dioxo-heterocyclic compound with the structural formula I could form a stable positive SEI protective film on the surface of the positive electrode plate before fluoroethylene carbonate (FEC) was decomposed into HF gas on the surface of the negative electrode plate, thereby avoiding the corrosion of the positive active material by HF gas, and further improving the high temperature storage performance of the lithium-ion battery. 1,3-dioxo-heterocyclic compound with the structural formula I of the present disclosure could also form a negative SEI protective film on the surface of the negative electrode plate together with fluoroethylene carbonate (FEC), and because 1,3-dioxo-heterocyclic compound with the structural formula I in the negative SEI protective film had a higher concentration of oxygen element, the transmission capability of the lithium ions on the negative SEI protective film on the surface of the negative active material was also improved, therefore the impedance of the lithium-ion battery was obviously decreased, and the low temperature discharge rate performance of the lithium-ion battery was improved. A similar result could be seen from a comparation between example 15 and comparative example 4.

As could be seen from the comparison between examples 1-5 and comparative example 6, as the weight percentage of FEC increased, the high temperature thickness expansion rate of the lithium-ion battery firstly decreased and then increased, and the low temperature discharge rate of the lithium-ion battery firstly increased and then decreased. When the weight percentage of FEC in the electrolyte of the lithium-ion battery was more than 8% (comparative example 6), the gas production problem of the lithium-ion battery would be aggravated.

As could be seen from the comparison among example 3, examples 6-9 and comparative example 5, as the weight percentage of 1,3-dioxo-heterocyclic compound with the structural formula I increased, the high temperature thickness expansion rate of the lithium-ion battery firstly decreased and then increased, and the low temperature discharge rate of the lithium-ion battery firstly increased and then decreased. And when the weight percentage of 1,3-dioxo-heterocyclic compound with the structural formula I was relatively low (example 6), the improving effect on the lithium-ion battery was not obvious; when the weight percentage of 1,3-dioxo-heterocyclic compound with the structural formula I was relatively high (comparative example 5), although it might significantly inhibit the corrosion on the positive active material by HF gas, however, the positive SEI protective film was relatively thick and dense, thereby hindering the normal deintercalation-intercalation process of the lithium ions, thereby resulting in a negative effect on the capacity of the lithium-ion battery, and also seriously affecting the low temperature discharge rate performance of the lithium-ion battery.

As could be seen from the comparison among example 3, example 11 and example 13, as the number of the substituent group increased, both the high temperature storage performance and the low temperature discharge rate performance of the lithium-ion battery became worse, this was because the configuration of the substituent group increased the steric hindrance in the formation of the SEI protective film, and further had a negative effect on the transmission capability of the lithium ions. A similar result could be seen from the comparison among example 10, example 12 and example 14.

As could be seen from the comparison among example 3, example 15 and example 16, the lithium-ion battery using NCM333 and NCM523 as the positive active material had a better high temperature storage performance and a better low temperature discharge rate performance than the lithium-ion battery using LCO as the positive active material. This was because 1,3-dioxo-heterocyclic compound with the structural formula I and FEC were more suitable for the ternary positive active material, therefore a better SEI protective film could be formed on the surface of the positive electrode plate; moreover, a pH value of the ternary positive active material was higher, and it could better catalyze 1,3-dioxo-heterocyclic compound with the structural formula I to participate in the formation of the positive SEI protective film, therefore the concentration of the oxygen element in the positive SEI protective film was higher, and thereby further improving the transmission rate of the lithium ions, and improving the high temperature storage performance and the low temperature discharge rate performance of the lithium-ion battery.

What is claimed is:

1. An electrolyte of a lithium-ion battery, comprising:
a non-aqueous organic solvent;
a lithium salt dissolved in the non-aqueous organic solvent; and
an additive dissolved in the non-aqueous organic solvent;
the additive comprising 1,3-dioxo-heterocyclic compound with a structural formula I and fluoroethylene carbonate; 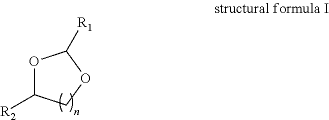
in the structural formula I, R₁ and R₂ each independently being H, methyl or ethyl; n being an integer selected from 1˜3;
a weight percentage of 1,3-dioxo-heterocyclic compound with the structural formula I in the electrolyte of the lithium-ion battery being 0.05%˜5%;
a weight percentage of fluoroethylene carbonate in the electrolyte of the lithium-ion battery being 1%˜8%.

2. The electrolyte of the lithium-ion battery according to claim 1, wherein the non-aqueous organic solvent comprises one or more selected from a group consisting of carbonate and carboxylate, the carbonate comprises cyclic carbonate and chain carbonate.

3. The electrolyte of the lithium-ion battery according to claim 2, wherein
the cyclic carbonate comprises one or more selected from a group consisting of propylene carbonate and ethylene carbonate;
the chain carbonate comprises one or more selected from a group consisting of dimethyl carbonate, ethyl methyl carbonate and methyl propyl carbonate;
the carboxylate comprises one or more selected from a group consisting of γ-butyrolactone, methyl formate, ethyl acetate and methyl butyrate.

4. The electrolyte of the lithium-ion battery according to claim 2,
a volume of the chain carbonate is 40%˜70% of a total volume of the non-aqueous organic solvent;
a volume of the carboxylate is 40%˜70% of the total volume of the non-aqueous organic solvent;
a volume of the cyclic carbonate is the residual percentage of the total volume of the non-aqueous organic solvent.

5. The electrolyte of the lithium-ion battery according to claim 3,
a volume of the chain carbonate is 40%˜70% of a total volume of the non-aqueous organic solvent;
a volume of the carboxylate is 40%˜70% of the total volume of the non-aqueous organic solvent;
a volume of the cyclic carbonate is the residual percentage of the total volume of the non-aqueous organic solvent.

6. The electrolyte of the lithium-ion battery according to claim 1, wherein 1,3-dioxo-heterocyclic compound with the structural formula I comprises one or more selected from a group consisting of 1,3-dioxane, 1,3-dioxolan, 2-methyl-1,3-dioxane, 2-methyl-1,3-dioxolan, 2,6-dimethyl-1,3-dioxane and 2,5-dimethyl-1,3-dioxolan,

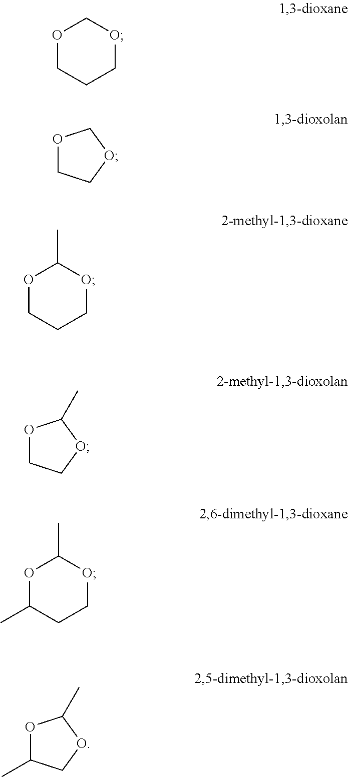

7. The electrolyte of the lithium-ion battery according to claim 1, wherein
the weight percentage of 1,3-dioxo-heterocyclic compound with the structural formula I in the electrolyte of the lithium-ion battery is 0.5%˜2%;
the weight percentage of fluoroethylene carbonate in the electrolyte of the lithium-ion battery is 2%˜4%.

8. A lithium-ion battery, comprising:
a positive electrode plate comprising a positive current collector and a positive film containing a positive active material and provided on the positive current collector;
a negative electrode plate comprising a negative current collector and a negative film containing a negative active material and provided on the negative current collector;
a separator positioned between the positive electrode plate and the negative electrode plate;
an electrolyte; and
an outer package;
the electrolyte comprising:
a non-aqueous organic solvent;
a lithium salt dissolved in the non-aqueous organic solvent; and
an additive dissolved in the non-aqueous organic solvent;
the additive comprising 1,3-dioxo-heterocyclic compound with a structural formula I and fluoroethylene carbonate; 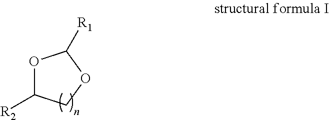
in the structural formula I, R₁ and R₂ each independently being H, methyl or ethyl; n being an integer selected from 1˜3;
a weight percentage of 1,3-dioxo-heterocyclic compound with the structural formula I in the electrolyte of the lithium-ion battery being 0.05%˜5%;
a weight percentage of fluoroethylene carbonate in the electrolyte of the lithium-ion battery being 1%˜8%.

9. The lithium-ion battery according to claim 8, wherein
the positive active material comprises a lithium deintercalateion-intercalation material;
the lithium deintercalateion-intercalation material is lithium transition metal complex oxide;
the lithium transition metal complex oxide comprises one or more selected from a group consisting of lithium transition metal oxide, a compound containg lithium transition metal oxide and other transition metal or nontransition metal;
the lithium transition metal complex oxide comprises one or more selected from a group consisting of lithium cobalt oxide, lithium nickel oxide, lithium manganese oxide, lithium nickel manganese oxide, lithium nickel cobalt manganese oxide and lithium nickel cobalt aluminum oxide.

10. The lithium-ion battery according to claim 9, wherein the lithium transition metal complex oxide comprises one or more selected from a group consisting of LiCoO₂, LiNi_{1/3}Mnᵤ₃CO_{1/3}O₂, LiNi_{0.5}Mn_{0.3}Co_{0.2}O₂, a compound containing LiCoO₂ and other transition metal, a compound containing LiNi_{1/3}Mn_{1/3}CO_{1/3}O₂ and other transition metal and a compound containing LiNi_{0.5}Mn_{0.3}CO_{0.2}O₂ and other transition metal.

11. The lithium-ion battery according to claim 8, wherein
the negative active material comprises a lithium deintercalateion-intercalation material,
the lithium deintercalateion-intercalation material comprises one or more selected from a group consisting of soft carbon, hard carbon, artificial graphite, natural graphite, silicon, silicon oxide, silicon carbon complex, lithium titanate and a metal which can form alloy with lithium.

12. The lithium-ion battery according to claim 8, wherein the non-aqueous organic solvent comprises one or more selected from a group consisting of carbonate and carboxylate, the carbonate comprises cyclic carbonate and chain carbonate.

13. The lithium-ion battery according to claim 12, wherein
the cyclic carbonate comprises one or more selected from a group consisting of propylene carbonate and ethylene carbonate;
the chain carbonate comprises one or more selected from a group consisting of dimethyl carbonate, ethyl methyl carbonate and methyl propyl carbonate;
the carboxylate comprises one or more selected from a group consisting of γ-butyrolactone, methyl formate, ethyl acetate and methyl butyrate.

14. The lithium-ion battery according to claim 12,
a volume of the chain carbonate is 40%˜70% of a total volume of the non-aqueous organic solvent;
a volume of the carboxylate is 40%˜70% of the total volume of the non-aqueous organic solvent;
a volume of the cyclic carbonate is the residual percentage of the total volume of the non-aqueous organic solvent.

15. The lithium-ion battery according to claim 13,
a volume of the chain carbonate is 40%˜70% of a total volume of the non-aqueous organic solvent;
a volume of the carboxylate is 40%˜70% of the total volume of the non-aqueous organic solvent;
a volume of the cyclic carbonate is the residual percentage of the total volume of the non-aqueous organic solvent.

16. The lithium-ion battery according to claim 8, wherein 1,3-dioxo-heterocyclic compound with the structural formula I comprises one or more selected from a group consisting of 1,3-dioxane, 1,3-dioxolan, 2-methyl-1,3-dioxane, 2-methyl-1,3-dioxolan, 2,6-dimethyl-1,3-dioxane and 2,5-dimethyl-1,3-dioxolan,

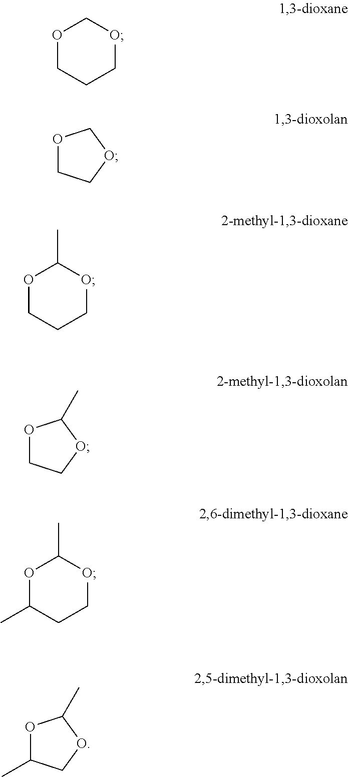

17. The lithium-ion battery according to claim 8, wherein
the weight percentage of 1,3-dioxo-heterocyclic compound with the structural formula I in the electrolyte of the lithium-ion battery is 0.5%˜2%;
the weight percentage of fluoroethylene carbonate in the electrolyte of the lithium-ion battery is 2%˜4%.
